(19) United States
(12) Patent Application Publication
(10) Pub. No.: US 2004/0222048 A1
(43) Pub. Date: Nov. 11, 2004

(54) Elevator system

(76) Inventors: Sueyoshi Mizuno, Tokyo (JP); Yoshiaki Fujita, Tokyo (JP); Norihito Togashi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/778,356

(22) Filed: Feb. 17, 2004

(30) Foreign Application Priority Data
Feb. 17, 2003 (JP) 2003-038273

(51) Int. Cl. B66B 11/02

(52) U.S. Cl. 187/401; 187/414; 187/413

(57) ABSTRACT

An elevator system comprises an air supply fan and an air exhaust fan which changes atmospheric pressure in a car according to an ascending and descending process, and a controller which rotates the air supply fan and the air exhaust fan in a normal direction or a reverse direction according to the ascending and descending process to pressurize or depressurize an inside of the car.

### CROSS-REFERENCE TO RELATED APPLICATIONS

This application is based upon and claims the benefit of priority from prior Japanese Patent Application No. 2003-038273, filed Feb. 17, 2003, the entire contents of which are incorporated herein by reference.

### BACKGROUND OF THE INVENTION

1. Field of the Invention

This invention relates to an elevator system including an elevator car installed in a high-rise building, an ultratall building, a super high-rise building, or the like with a long ascending and descending distance.

2. Description of the Related Art

Generally, an elevator system installed in a high-rise building, an ultratall building, a super high-rise building, or the like with a long ascending and descending distance uses a method of providing the elevator car with a pressure control unit and alleviating such discomfort as passengers' ear trouble or dizziness by changing the atmospheric pressure in the car according to the ascending and descending process (Japanese Patent Application KOKAI Publication No. 10-182039).

FIG. 1 shows the configuration of an elevator system having a car provided with a pressure control unit disclosed in the publication.

The pressure control unit comprises an air supply fan 52a and an air exhaust fan 52b which are provided on the top of a car 51, a microcomputer 53 which outputs control instructions to change the atmospheric pressure in the car 51 according to the ascending and descending process, and inverters 54a, 54b which control the number of revolutions of the air supply and exhaust fans 52a, 52b on the basis of the control instructions output from the microcomputer 53. Numeral 55a indicates a piping tube which is connected between the air supply fan 52a and the car 51 and supplies a pressurizing air to the car 51. Numeral 55b indicates a piping tube which is connected between the air exhaust fan 52b and the car 51 and exhausts the air in the car 51 into an ascending and descending path outside the car to reduce the pressure in the car 51. Numeral 56 indicates car doors in the open state.

In the pressure control unit configured as described above, when the microcomputer 53 outputs a control instruction according to the ascending and descending process, the inverters 54a, 54b produce the number of revolutions according the control instruction and perform control by operating the air supply and exhaust fans 52a, 52b alternately in such a manner that the atmospheric pressure in the car 51 changes at almost a constant rate from the starting floor to the landing floor.

Therefore, in the elevator system, although the pressure control unit itself can change the atmospheric pressure in the car 51 according to the ascending and descending process, the following problems have been pointed out:

(1) The atmospheric pressure in the car 51 is changed by using the air supply and exhaust fans 52a, 52b. However, the sound of air flow resulting from the supply or exhaust of air by the air supply and exhaust fans 52a, 52b makes a noise in the car 51, which might make passengers uncomfortable.

(2) When the atmospheric pressure in the car 51 is changed, the air in the car 51 leaks from the space between the car 51 and the doors 56 provided on the car 51. The air leaking sound produced at that time makes a noise, which might make passengers uncomfortable.

### BRIEF SUMMARY OF THE INVENTION

This invention is directed to a method and apparatus that substantially obviates one or more of the problems due to limitations and disadvantages of the related art.

An object of this invention is to provide an elevator system which reduces noise in the car and alleviates discomfort to passengers.

According to an embodiment of this invention, an elevator system comprises an air supply fan and an air exhaust fan which changes atmospheric pressure in a car according to an ascending and descending process; and a controller which rotates the air supply fan and the air exhaust fan in a normal direction or a reverse direction according to the ascending and descending process to pressurize or depressurize an inside of the car.

According to another embodiment of this invention, an elevator system comprises a car with a door; and a rectifying member which is provided near a space between a door peripheral component section for the car and the door and rectifies air flowing into and out of the car through the space.

Additional objects and advantages of this invention will be set forth in the description which follows, and in part will be obvious from the description, or may be learned by practice of this invention.

The objects and advantages of this invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of this invention and, together with the general description given above and the detailed description of the embodiments given below, serve to explain the principles of this invention in which:

FIG. 1 shows the configuration of an atmospheric pressure control unit which controls atmospheric pressure in a conventional car;

FIG. 2 shows a form of a high-rise building to which an elevator system according to an embodiment of this invention is applied;

FIG. 3 shows the configuration of an atmospheric pressure control unit which controls atmospheric pressure in a car of the embodiment;

FIG. 4 is a front view of the car of the embodiment;

FIG. 5 shows a configuration to help explain a concrete embodiment of an elevator system according to this invention, especially the relationship between the entrance posts and car doors constituting the car;

FIG. 6 shows a configuration to help explain a concrete embodiment of an elevator system according to this invention, especially the relationship between the modesty panels and car doors constituting the car;

FIG. 7 shows a configuration to help explain a concrete embodiment of an elevator system according to this invention, especially an enlarged front view of the door mating part and the lower parts of the car door; and

FIG. 8 is a sectional view of the door mating part in the lower part of the car door.

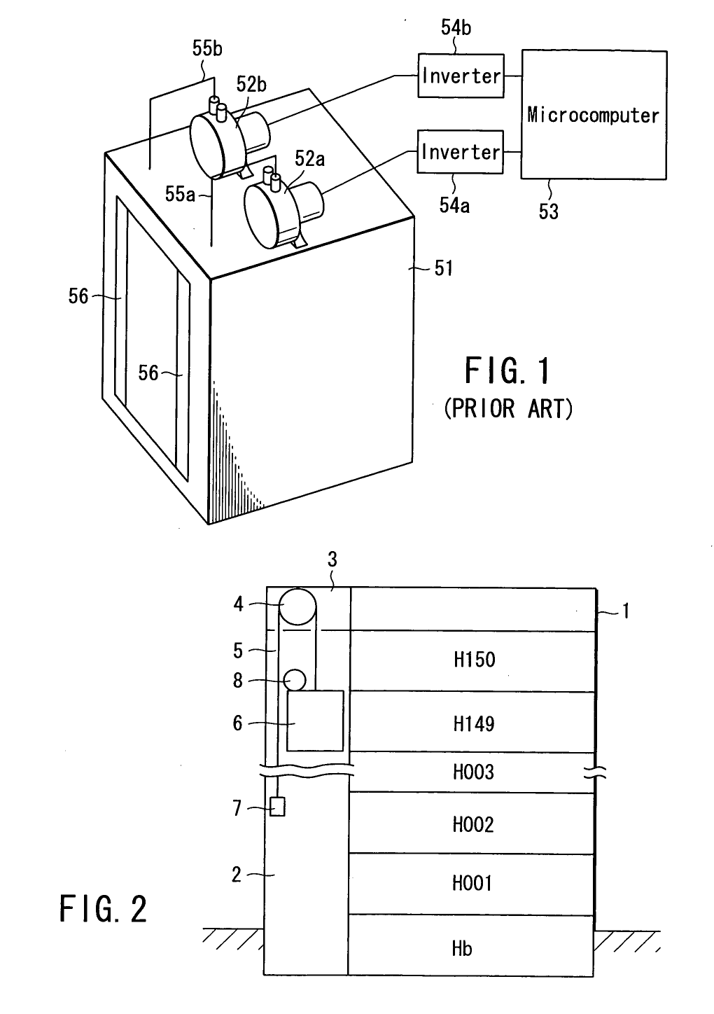

### DETAILED DESCRIPTION OF THE INVENTION

An embodiment of an elevator system according to this invention will now be described with reference to the accompanying drawings.

First Embodiment

FIG. 2 is a diagram to help explain a form of the installation of an embodiment of an elevator system according to this invention.

At a periphery portion of a high-rise building 1, including an ultratall building and a super high-rise building, for example, at the left end in FIG. 2, an ascending and descending path 2 is formed. To the right of the ascending and descending path 2 in FIG. 2, a basement platform hall Hb and a first-floor platform hall H001 to a 150th-floor platform hall H150 are formed.

In the upper part of the ascending and descending path 2, there is provided a machinery room 3. In the machinery room 3, a rope-type hoist 4 is installed. A box-like car 6 is suspended from one end of a hoist cable 5 wound around the sheave of the hoist 4. A counterweight 7 is suspended from the other end of the hoist cable 5. Therefore, when the hoist 4 is rotated under the control of an elevator main control unit (not shown) connected to the hoist 4, the car 6 goes up or down via the hoist cable 5.

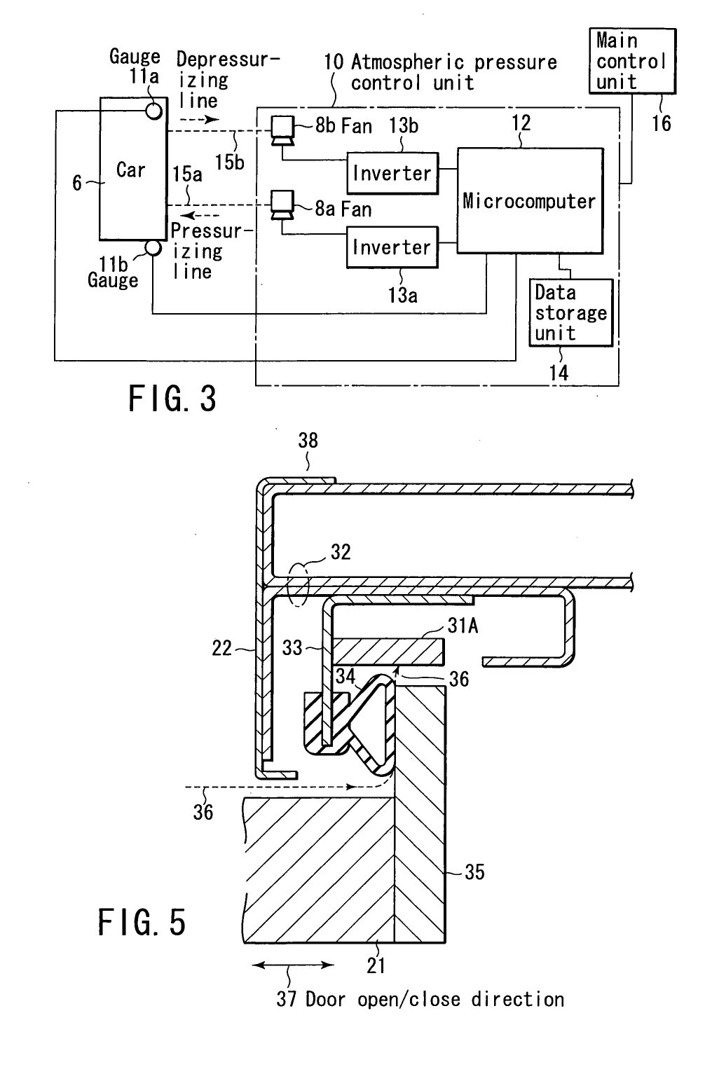

On the outside top of the car 6, a ventilator 8 is provided. The ventilator 8 comprises at least two fans 8a, 8b as shown in FIG. 3 explained later. One of the fans 8a, 8b functions as an air supply fan in the normal rotation and the other functions as an air exhaust fan in the normal rotation.

FIG. 3 shows the configuration of an atmospheric pressure control unit 10 which controls the atmospheric pressure in the car 6.

The atmospheric pressure control unit 10 comprises an indoor absolute pressure gauge 11a and an outdoor absolute pressure gauge 11b which measure the atmospheric pressure inside and outside the car 6 respectively, a microcomputer 12 which comprises a CPU that outputs a control instruction to change the atmospheric pressure in the car 6 on the basis of the atmospheric pressure data measured by at least the indoor absolute pressure gauge 11a, an air supply inverter 13a which controls the number of revolutions of the air supply fan 8a on the basis of the control instruction output from the microcomputer 12, and an air exhaust inverter 13b which controls the number of revolutions of the air exhaust fan 8b. The microcomputer 12 is provided with a setting data storage unit 14 which stores various types of setting data.

The control instructions output from the microcomputer 12 are to specify rotation control including the start and stop of the air supply fan 8a and air exhaust fan 8b. In addition, the control instructions output from the microcomputer 12 include an instruction to cause the two fans 8a, 8b to function as air supply fans or air exhaust fans or only one of the fans 8a, 8b to function as an air supply fan or an-air exhaust fan.

The air supply fan 8a, which has its air outlet connected to the car 6 via a piping tube 15a, takes in air from its air inlet (not shown) made on the ascending and descending path 2 side and supplies air to the car 6. The air exhaust fan 8b, which has its air outlet connected to the car 6 via a piping tube 15b, exhausts the air in the car 6 into the ascending and descending path 2 outside the car 6. The ports opposite to the air inlet of the fan 8a and the air outlet of the fan 8b, that is, the connection ports of the piping tubes 15a, 15b, face the ascending and descending path 2 side and are at atmospheric pressure. Therefore, when the air supply and exhaust fans 8a, 8b are not in operation, the inside of the car 6, which is connected to the inside of the ascending and descending path 2, is at atmospheric pressure. In the figure, numeral 16 is an elevator main control unit which performs control of a series of operations of the elevator system.

Next, the operation of controlling each of the fans 8a, 8b on the basis of the control instructions from the microcomputer 12 will be explained.

For example, when the car 6 goes down from the top floor to any floor above the ground, the microcomputer 12, in the first half of the time zone of the total descending process, or in the time zone that the car 6 has not reached the maximum descending speed, causes not only the air supply fan 8a to rotate in the normal direction via the air supply inverter 13a to supply air to the car 6 but also the air exhaust fan 8b to rotate in the reverse direction at a specific number of revolutions on the basis of the atmospheric pressure data measured by the indoor absolute pressure gauge 11a and the outdoor atmospheric pressure data stored in the setting data storage unit 14 to supply air to the car 6, thereby setting the atmospheric pressure in the car 6 higher than the outdoor atmospheric pressure. That is, the pressure control unit 10 causes both of the air supply fan 8a and air exhaust fan 8b to perform an air intake operation so as to raise the atmospheric pressure in the car 6.

Furthermore, near the maximum descending speed, the microcomputer 12 causes not only the air exhaust fan 8b to rotate in the normal direction to exhaust the air from the car 6 but also the air supply fan 8a to rotate in the reverse direction to exhaust the air from the car 6, thereby setting the atmospheric pressure in the car 6 lower than the outdoor atmospheric pressure. That is, the pressure control unit 10 causes both of the air supply fan 8a and air exhaust fan 8b to perform an air exhaust operation so as to reduce the atmospheric pressure in the car 6.

Therefore, when the air supply fan 8a and air exhaust fan 8b are rotated in different directions as described above, this pressurizes or depressurizes the car 6, which makes it possible to decrease the flow rate of air to change the atmospheric pressure in the car 6.

Conversely, when the car 6 goes up from any floor above the ground to the top floor, the microcomputer 12, in the first half of the time zone of the total ascending process, or in the time zone that the car 6 has not reached the maximum ascending speed, causes not only the air exhaust fan 8b to rotate in the normal direction to exhaust air from the car 6 but also the air supply fan 8a to rotate in the reverse direction on the basis of the atmospheric pressure data measured by the indoor absolute pressure gauge 11a and the outdoor atmospheric pressure data stored in the setting data storage unit 14 to exhaust the air from the car 6, thereby setting the atmospheric pressure in the car 6 lower than the outdoor atmospheric pressure. That is, the pressure control unit 10 causes both of the air exhaust fan 8b and air supply fan 8a to perform an air exhaust operation so as to reduce the atmospheric pressure in the car 6. Furthermore, near the maximum ascending speed, the microcomputer 12 causes not only the air supply fan 8a to rotate in the normal direction to supply air to the car 6 but also the air exhaust fan 8b to rotate in the reverse direction to supply air to the car 6, thereby setting the atmospheric pressure in the car 6 higher than the outdoor atmospheric pressure. That is, the pressure control unit 10 causes-both of the air exhaust fan 8b and air supply fan 8a to perform an air intake operation so as to reduce the atmospheric pressure in the car 6. Therefore, by rotating the air supply fan 8a and air exhaust fan 8b in different directions as described above, the flow rate of air to change the atmospheric pressure in the car 6 can be decreased.

Accordingly, with the first embodiment, controlling the rotation of the two fans 8a, 8b in the pressurizing and depressurizing directions makes it possible to decrease the flow rate of air supplied from or exhausted by the air supply fans 8a and air exhaust fan 8b to change atmospheric pressure in the car 6. As a result, the sound of air flow from the air supply fan 8a and air exhaust fan 8b can be reduced and therefore noise in the car 6 can be reduced, which enables discomfort to passengers to be reduced.

Other embodiments of the elevator system according to this invention will be described. The same portions as those of the first embodiment will be indicated in the same reference numerals and their detailed description will be omitted.

Second Embodiment

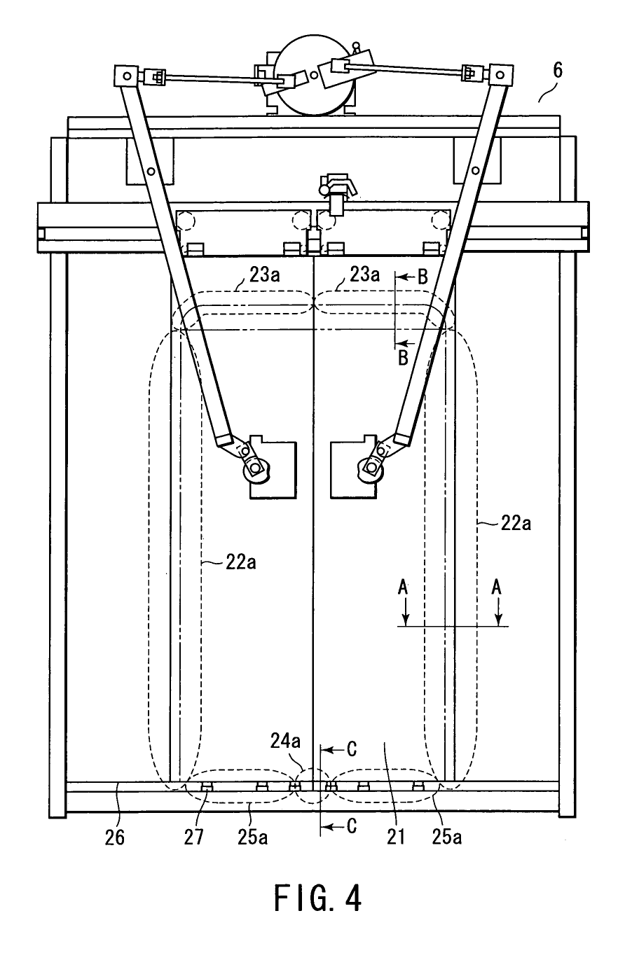

FIG. 4 is a front view of a car to help explain another embodiment of an elevator system according to this invention.

The second embodiment aims to reduce the sound of leaking air flowing through the space between the door peripheral component member of the car 6 and car doors 21 provided to the car 6.

The car 6 comprises a car floor, sideboards serving as car walls, a ceiling board provided so as to cover the tops of the sideboards, bases provided between the car floor and the sideboards, entrance posts constituting the car door frame, modesty panels, and car doors 21. Since the car doors 21 are movable, there is a little space between the door peripheral component member (entrance posts 22a, modesty panel sections 23a, door mating lower parts 24a, and door lower parts 25a) constituting the peripheral parts of the car doors 21 and the car doors 21. Numeral 26 indicates a sill. Numeral 27 indicates guide shoes.

In the second embodiment, an air sound rectifying member to reduce leaking sound produced when air leaks (see FIGS. 5 to 8) is provided at the space between the door peripheral component part and the car door 21. Fur material, such as soft fur, is used as the air sound rectifying member 31. An artificial fiber member may be used as the air sound rectifying member 31.

The operation of the second embodiment as described above will be explained.

In the prior art, when the car doors 21 are closed, there is a little space between the door peripheral component section of the car 6 and the car doors 21 installed on the car 6. A seal 34 (explained later) provided to the door peripheral component section of the car 6 and others is crushed by a seal holding member 35 (explained later) provided to the car door 21, which decreases air leaks from the space between the door peripheral component section of the car 6 and the car door 21 but cannot prevent the air leak completely.

To overcome this problem, the air sound rectifying member 31 is provided at the space between the door peripheral component section of the car 6 and the car door 21, thereby rectifying the air flowing through the space with the air sound rectifying member 31, which makes it possible to decrease leaking sound produced when air leaks and therefore lead to a remarkable reduction in noise offending the passengers' ears in the car.

Hereinafter, an example of providing the air sound rectifying member 31 near the space between the door peripheral component section of the car 6 and the car door 21 will be explained concretely by reference to FIGS. 5 to 8.

FIG. 5 is a sectional view taken along line A-A of FIG. 4, which shows an example of providing an air sound rectifying member 31A between the entrance post 22, an entrance peripheral component member, and the car door 21.

Of the double doors 21 of the car 6, FIG. 5 particularly shows the relationship between a part of the right-side car door 21 when viewed from the outside and the entrance post 22. The car doors 21 are kept closed.

On the outside of the entrance post 22, L-shaped entrance post car panels 32 are provided in such a manner that they are set back to back. On the surface of the entrance post car panel 32 on the car side, .a seal support member 33 is provided so as to stand straight. At the tip of the seal support member 33, there is provided an entrance post seal 34 made of elastically deformable material in the form of an inverted triangle.

On the other hand, an entrance post seal holding member 35 for holding the surface of the entrance post seal 34 when the double car doors 21 are closed is provided at the right-side end of the car door 21. On the same side of the mounting surface of the entrance post seal 34 of the seal support member 33, there is provided an air sound rectifying member 31A for rectifying air leaking from the inside of the car 6 through the space between the entrance post seal 34 and the entrance post seal holding member 35.

In the figure, numeral 37 indicates the directions in which the car doors 37 are opened and closed. Numeral 38 indicates the inside of the car.

Since the related members including the left-side car door and the left-side entrance post have the same configuration as those including the right-side car door 21 and entrance post 22, an explanation of them will be omitted.

Next, the operation of the rectifying member 31A configured as described above will be explained.

When the car door 21 is closed, the car door 21 moves to the left 37 in the figure. At this time, since the entrance post seal 34 provided on the seal support member 33 faces the entrance post seal holding member 35 provided on the car door 21 each other, as the car door 21 is closed gradually, the entrance post seal holding member 35 approaches the entrance post seal 34 gradually. When the car door 21 is closed completely, the entrance post seal holding member 35 has crushed the entrance post seal 34, with the result that the leaking of air from the space between the entrance post 22 and the car door 21 decreases.

As described above, the sound of air leaking through the space between the entrance post 22 and the car door 21, that is, between the entrance post seal 34 and the entrance post seal holding member 35, can be reduced to some extent. However, because of various factors, including a longtime use of the car 6 and the deformation of the entrance post seal 34 resulting from an increase in the number of openings and closings of the car door, air will leak as shown by the arrow 36 in the figure. Therefore, it is difficult to prevent air leaks.

To overcome this problem, the air sound rectifying member 31A is provided at the part where air leaks from the space between the entrance post seal 34 and the entrance post seal holding member 35. The air sound rectifying member 31A absorbs a part of the leaking air, while being pressed by the flow of the leaking air. The remaining air passes through the air sound rectifying member 31A, thereby rectifying the leaking air.

Therefore, since the air leaking from the space between the entrance post seal 34 and the entrance post seal holding member 35 is rectified by the air sound rectifying member 31A, sound produced by air flowing in and out of the car 6 can be reduced and therefore noise offending passengers' ears in the car 6 can be reduced remarkably.

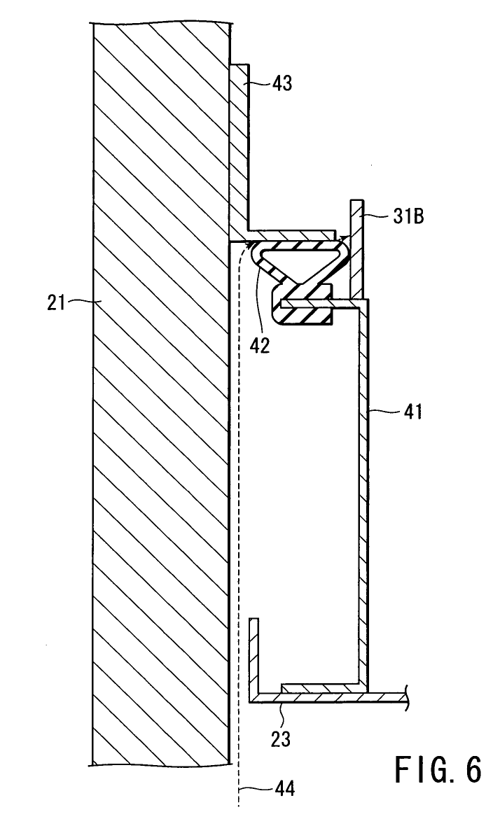

FIG. 6 is a sectional view taken along B-B of FIG. 4, which particularly shows an example of providing an air sound rectifying member 31B between the modesty panel 23, a door peripheral component member, and the car door 21.

In FIG. 6, numeral 23 indicates a modesty panel provided in the upper part of the car 6. On the modesty panel 23, a square-bracket-shaped modesty panel car panel 41 is provided inside of the car 6. A modesty panel seal 42 whose cross section is shaped like an inverted triangle and which is made of elastically deformable material is provided at the top end of the modesty panel car panel 41.

On the other hand, a modesty panel seal holding member 43 is provided in the upper part of the inner side face of the car door 21. When the car door 21 is opened, the modesty seal holding member 43 is a little higher than the modesty panel seal 42. However, when the car door 21 is closed, the modesty panel seal holding member 43, together with the car door 21, goes down a little, with the result that the modesty panel seal holding member 43 crushes the modesty panel seal 42, thereby reducing the leaking of air from the space between the modesty panel 23 and the car door 21.

As described above, the leaking of air through the space between the modesty panel 23 and the car door 21, that is, between the modesty panel seal 42 and the modesty panel seal holding member 43, can be reduced to some extent. However, because of various factors, including a longtime use of the car 6 and the deformation of the entrance post seal 34 resulting from an increase in the number of openings and closings of the car door, air will leak as shown by the arrow 44 in the figure. Therefore, it is difficult to prevent air leaks.

To overcome this problem, the air sound rectifying member 31B is provided at the part where air leaks from the space between the modesty panel seal 42 and the modesty panel seal holding member 43. The leaking air passes through the air sound rectifying member 31B, which rectifies the leaking air.

Therefore, since air leaking from the space between the modesty panel seal 42 and the modesty seal holding member 43 is rectified by the air sound rectifying member 31B, leaking sound produced when air passing through the space leaks can be reduced and therefore noise offending passengers' ears in the car can be reduced remarkably.

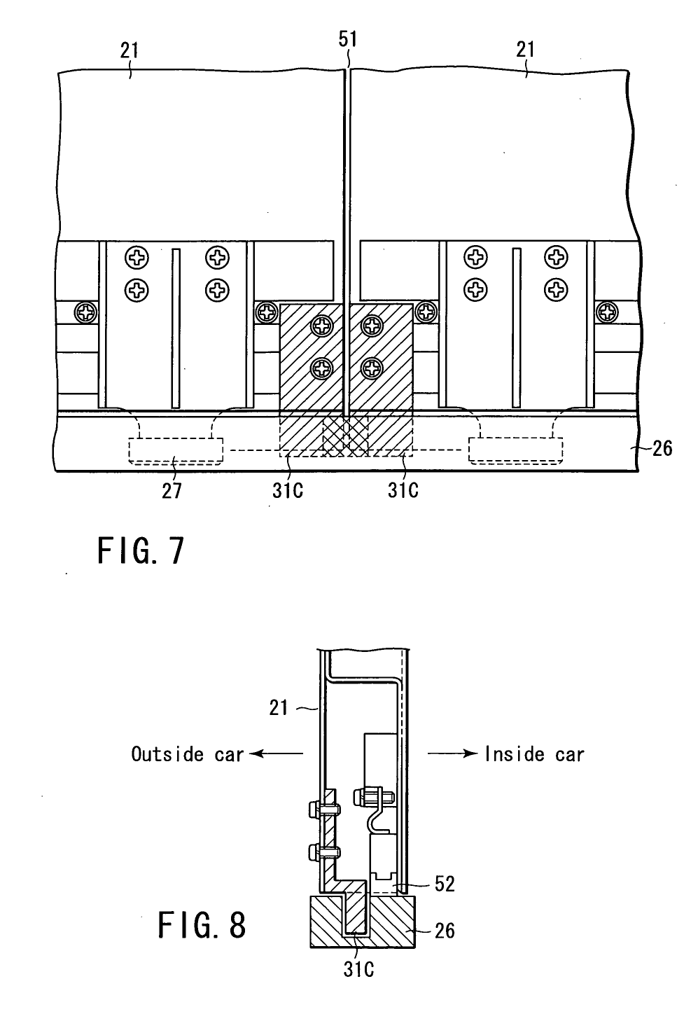

FIGS. 7 and 8 show examples of providing rectifying members 31C to the door mating lower part 24a and door lower parts 25a. FIG. 7 is a front view of the door mating lower parts 24a and door lower parts 25a of FIG. 4. FIG. 8 is a sectional view taken along line C-C of FIG. 4.

As shown in FIG. 7, a door mating rubber 51 is provided on the door mating part of each of the double car doors 21.

Furthermore, as shown in FIG. 8, a door lower part seal 52 is provided in the lower part of the car door 21. When the car door 21 is opened, the door lower part seal 52 is a little higher than the sill 26. When the car door 21 is closed, it goes down a little, with the result that the door lower part seal 52, together with the car door 21, goes down and presses against the sill 26.

Therefore, when the car doors 21 are closed, the mating rubbers 51 of the double car doors contact each other, which prevents air from leaking from the door mating parts. Furthermore, since the door lower part seal presses against the sill 26 when the car doors are opened and closed, the leaking of air from the clearance with each door lower part 25a decreases.

Accordingly, with the above-described configuration, the leaking of air through the space between each car door lower part and the door mating part can be reduced to some extent. However, because of various factors, including a longtime use of the car 6 and the deformation of the door lower part 52 resulting from an increase in the number of openings and closings of the car door, air will leak. Therefore, it is difficult to prevent air leak.

To overcome this problem, using the groove in the sill 26, the air sound rectifying-member 31C is provided in the vicinity of each of the door mating lower parts of the double car doors 21 in such a manner that the lower end of the air sound rectifying member 31C hangs down in the groove in the sill 26.

As a result, since the air flowing out of the vicinity of the door mating lower parts of the double car doors 21 is rectified by the air sound rectifying member 31C, sound produced by air flowing in and out of the car can be reduced and therefore noise offending passengers' ears in the car can be reduced remarkably.

Furthermore, the air sound rectifying member 31C also has the function of clearing dust or sand attaching to the groove in the sill 26.

According to an embodiment of this invention, an elevator system comprises an air supply fan and an air exhaust fan which are for changing atmospheric pressure in a car according to an ascending and descending process, and an atmospheric pressure control unit including controller for rotating both of the air supply fan and air exhaust fan in a normal direction or a reverse direction according to the ascending and descending process to pressurize or depressurize the inside of the car.

According to this embodiment, for example, when the car goes down from the top floor to any floor above the ground, the air supply fan is rotated in the normal direction and the air exhaust fan is rotated in the reverse direction in the first half of the time zone of the total descending process, thereby depressurizing the car, which makes it possible to decrease the flow rate of air to change the atmospheric pressure in the car. As a result, not only the sound of air flow from the air supply and exhaust fans but also noise in the car can be reduced and therefore discomfort to the passengers can be alleviated.

According to another embodiment of this invention, a rectifying member for rectifying the sound of leaking air flowing in and out of the car through a space between the door peripheral component section constituting the car and the car door is provided near the space. This configuration not only produces the effect of the above configuration but also the following effect: although the sound of leaks is produced by air flowing in and out of the car through the space, rectifying the leaking sound with the rectifying member enables not only the leaking sound but also noise in the car to be reduced, which makes it possible to alleviate discomfort to the passengers.

Near the space between the door peripheral component section constituting the car and the car doors, there may be provided a rectifying member which rectifies the sound of leaking air flowing in and out of the car through the space.

As has been described above, according to the embodiments of this invention, it is possible to provide an elevator system capable of decreasing the sound of air flow caused by fans and the sound of air leaks from the car, reducing noise the passengers in the car feel, and alleviating discomfort to the passengers.

This invention is not limited to the above embodiments and may be practiced or embodied in still other ways without departing from the spirit or essential character thereof. While in the embodiments, the hoist 4 has been installed in the machinery room 3, it goes without saying that this invention may be applied to an elevator system without a machinery room which has the hoist, control unit, and others installed in the ascending and descending path to eliminate the machinery room 3. Furthermore, while in the embodiments, the sound of air leaking from the inside of the car 6 has been reduced, it goes without saying that the sound of air flowing from outside the car 6 into the inside of the car 6 can be reduced. In addition, while the air sound rectifying member 31 has been installed mainly on the car 6, it goes without saying that the air sound rectifying member 31 may be provided on the double car doors 21, thereby reducing noise similarly.

What is claimed is:

1. An elevator system comprising:
an air supply fan and an air exhaust fan which changes atmospheric pressure in a car according to an ascending and descending process; and
a controller which rotates the air supply fan and the air exhaust fan in a normal direction or a reverse direction according to the ascending and descending process to pressurize or depressurize an inside of the car.

2. The elevator system according to claim 1, wherein
the controller, when pressurizing the inside of the car, rotates the air supply fan in the normal direction and the air exhaust fan in the reverse direction and, when depressurizing the inside of the car, rotates the air supply fan in the reverse direction and the air exhaust fan in the normal direction.

3. The elevator system according to claim 1, further comprising:
a rectifying member which is provided near a space between a door peripheral component section for the car and a car door and rectifies air flowing into and out of the car through the space.

4. The elevator system according to claim 3, wherein the door peripheral component section includes one or more of input posts, modesty panels, and car door mating section lower parts which constitute the car.

5. The elevator system according to claim 3, wherein the rectifying member is made of fur material.

6. An elevator system comprising:
a car with a door; and
a rectifying member which is provided near a space between a door peripheral component section for the car and the door and rectifies air flowing into and out of the car through the space.

7. The elevator system according to claim 6, wherein the door peripheral component section includes one or more of input posts, modesty panels, and car door mating section lower parts which constitute the car.

8. The elevator system according to claim 7, wherein the rectifying member is made of fur material.
